(19) United States
(12) Patent Application Publication
(10) Pub. No.: US 2026/0303566 A1
(43) Pub. Date: Oct. 1, 2026

(54) PROTECTING SECURITY IN COMMON TRUSTED APPLICATION

(71) Applicant: QUALCOMM Incorporated, San Diego, CA (US)

(72) Inventors: Vishal CHOPRA, Hyderabad (IN); Ananda Kishore PARASA, Hyderabad (IN); Danis RYBNIKOV, Zichron Yakov (IL); Alex KHUSIDMAN, Haifa (IL)

(21) Appl. No.: 19/481,163

(22) PCT Filed: May 9, 2024
(86) PCT No.: PCT/US2024/028650

§ 371 Date: Nov. 3, 2025

(30) Foreign Application Priority Data
May 12, 2023 (IN) 202341033635

(51) Int. Cl. H04L 9/40

(52) U.S. Cl. CPC H04L 63/0236; H04L 63/166

(57) ABSTRACT

Systems and techniques are provided for establishing a connection. For instance, a process may include receiving, by a front-end application executing on a first virtual machine of an electronic device, a request to establish a first socket connection to a back-end application, the request including a first user identifier (UID) of the front-end application and a first socket identifier; determining that the first UID matches a predetermined UID and that the first socket identifier matches a predetermined socket identifier; establishing the first socket connection to the back-end application based on the determination that the first UID matches the predetermined UID and the first socket identifier matches the predetermined socket identifier; and transmitting the request to establish the first socket connection to the back-end application to communicate with a trusted application.

### FIELD

Aspects of the present disclosure generally relate to device security. For example, aspects of the present disclosure relate to protecting security for a common trusted application.

### INTRODUCTION

Computing devices typically store sensitive data owned by users or enterprises, with firmware or operating system software on the computing devices owned by a computing device or secure module manufacturer. To help secure computing devices, the firmware or software may include security measures to protect against, e.g., removing brute force attack mitigations, disabling secure boot/trust boot, and/or loading other unauthenticated firmware or software on the computing devices.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for device security. According to at least one illustrative example, an electronic device is provided. The electronic device includes a memory; and a processor coupled to the memory. The processor is configured to: receive, by a front-end application executing on a virtual machine of the electronic device, a request to establish a socket connection to a back-end application, the request including a first user identifier (UID) of the front-end application and a first socket identifier; determine that the first UID matches a predetermined UID and that the first socket identifier matches a predetermined socket identifier; establish a socket connection to the back-end application based on the determination that the first UID matches the predetermined UID and the first socket identifier matches the predetermined socket identifier; and transmit the request to establish the socket connection to the back-end application to communicate with a trusted application.

As another example, a method for establishing a connection is provided. The method includes: receiving, by a front-end application executing on a virtual machine of an electronic device, a request to establish a socket connection to a back-end application, the request including a first user identifier (UID) of the front-end application and a first socket identifier; determining that the first UID matches a predetermined UID and that the first socket identifier matches a predetermined socket identifier; establishing a socket connection to the back-end application based on the determination that the first UID matches the predetermined UID and the first socket identifier matches the predetermined socket identifier; and transmitting the request to establish the socket connection to the back-end application to communicate with a trusted application.

In another example, a non-transitory computer-readable medium is provided. The non-transitory computer-readable medium has stored thereon instructions that, when executed by a processor, cause the processor to: receive, by a front-end application executing on a virtual machine of an electronic device, a request to establish a socket connection to a back-end application, the request including a first user identifier (UID) of the front-end application and a first socket identifier; determine that the first UID matches a predetermined UID and that the first socket identifier matches a predetermined socket identifier; establish a socket connection to the back-end application based on the determination that the first UID matches the predetermined UID and the first socket identifier matches the predetermined socket identifier; and transmit the request to establish the socket connection to the back-end application to communicate with a trusted application.

As another example, an apparatus for establishing a connection is provided. The apparatus includes: means for receiving, by a front-end application executing on a virtual machine of an electronic device, a request to establish a socket connection to a back-end application, the request including a first user identifier (UID) of the front-end application and a first socket identifier; means for determining that the first UID matches a predetermined UID and that the first socket identifier matches a predetermined socket identifier; means for establishing a socket connection to the back-end application based on the determination that the first UID matches the predetermined UID and the first socket identifier matches the predetermined socket identifier; and means for transmitting the request to establish the socket connection to the back-end application to communicate with a trusted application.

Aspects generally include a method, apparatus, system, computer program product, non-transitory computer-readable medium, user equipment, base station, wireless communication device, and/or processing system as substantially described herein with reference to and as illustrated by the drawings and specification.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example implementation of a system-on-a-chip (SOC), in accordance with some examples;

FIG. 2 is a block diagram illustrating communications between a set of VMs, in accordance with aspects of the present disclosure;

FIG. 3 is a block diagram illustrating protected communications between a set of VMs, in accordance with aspects of the present disclosure;

FIG. 4 is flow diagram illustrating an example of a process for establishing a connection, in accordance with some examples; and

FIG. 5 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Aspects of the present disclosure address techniques to protect security for a common trusted application. In some cases, the trusted application may be an application with special privileges and/or has been specially vetted for use and a trusted application may be capable of bypassing certain security controls. In some cases, a trusted application may be accessed by multiple other client applications. For example, a trusted application may be accessed by a back-end application (e.g., a server application being executed by a server computing device) and multiple client applications may send requests to the back-end application. In some cases, trusted applications may be sand-boxed such that clients from (e.g., applications executing on) other virtual machines (VMs) may not be able to directly access the trusted application. Instead, other applications may access the trusted application via the back-end application that may be running on a primary VM (PVM) or host computer. For example, the back-end application may be executing on a separate VM and one or more client applications may be executing in other VMs.

In some cases, a first application executing in a first VM may communicate with a third application executing in a third VM using sockets. For example, the first application may use a particular socket identifier, associated with the first VM, to access the third application. Generally, different VMs may be associated with different socket identifiers. In some cases, if a second application on a second VM uses a socket identifier associated with the first VM or third VM to communicate with a trusted application, either maliciously or unknowingly, this may be problematic.

Systems, apparatuses, processes (also referred to as methods), and computer-readable media (collectively referred to as “systems and techniques”) are described herein for providing protecting security for a common trusted application. For example, the systems and techniques described herein can be used to establish a connection with a back-end application for accessing a common trusted application using a front-end application. A front-end application may be an application, or interfaces of an application, which are accessible to a user, client, third-parties, etc. The front-end application may be executed on a same VM as a client application attempting to access the common trusted application. The client application may attempt to establish a socket connection to a back-end application that can access the common trusted application by sending a request to establish the socket connection to the front-end application. A back-end application may be an application or parts of an application which are not directly accessible to a user client, third-parties, etc. In some cases, a back-end application may be accessible to a user, client, third-parties, etc., via a front-end application. A socket connection may be an established communications link between processes and/or logical devices which may be bound to a certain port. The request may include a unique user identifier (UID) (or other similar unique identifier) and a socket identifier. The UID and socket identifier may be associated with the front-end application and may be predetermined, for example, during a compile process for the front-end application.

In some cases, the front-end application may be a filter application that detects and filters attempts to establish a socket connection to the back-end application. As an example, the front-end application may be an extended Berkeley packet filter. In some cases, the front-end application may detect attempts to establish a socket connection to the back-end application and determine that the attempts (e.g., the request) may have an incorrect UID and/or socket identifier (e.g., different from the predetermined ones). In such cases, the front-end application may drop such requests. A dropped request may be discarded, deleted, cleared, ignored, etc. Where the UID and socket identifier match the predetermined ones, the front-end application may establish a socket connection with the back-end application and forward such requests to the back-end application. The front-end application may receive responses from the back-end application and may forward the received response to the appropriate client application.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “mobile device” is used herein to refer to any one or all of cellular telephones, smartphones, Internet-of-things (IoT) devices, personal or mobile multimedia players, laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals to/from wireless communication networks. While the various embodiments are particularly useful in mobile devices, such as smartphones and tablets, the embodiments are generally useful in any electronic device that includes secure boot circuitry for securing access to the electronic device.

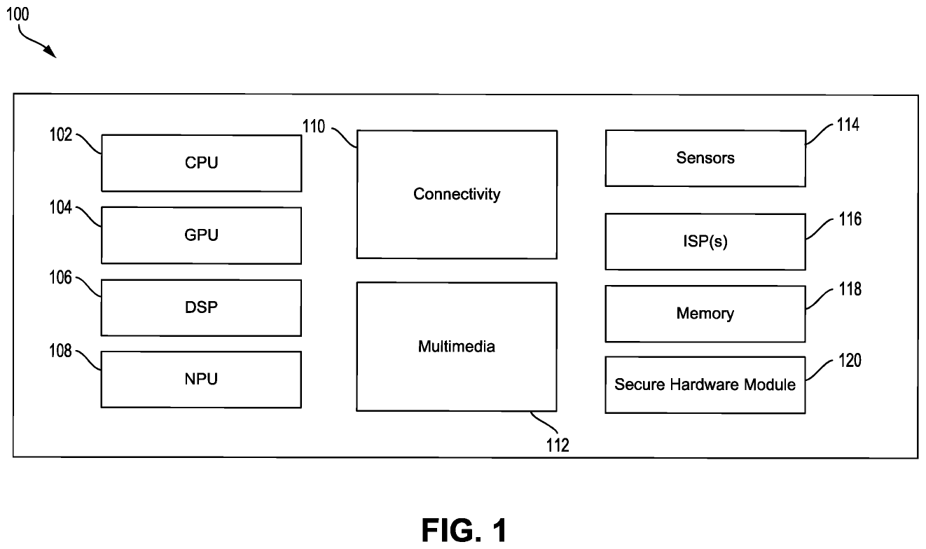

Various aspects of the techniques described herein will be discussed below with respect to the figures. FIG. 1. FIG. 1 illustrates an example implementation of a system-on-a-chip (SOC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

In some cases, the SOC 100 may be based on an ARM instruction set. The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SOC 100 may also include a sensor processor 114, image signal processors (ISPs) 116, and/or a secure hardware module 120. The secure hardware module 120 may include fuses, replay protected memory block (RPMB), secure bits, secure flags, security enabled hardware, secure memory, or hardware, software, or firmware used to implement a secure portion of the operating system, a secure operating system (SOS), a trusted execution environment (TEE), etc.

In some cases, virtual machines (VM) may be used to distribute computing resources to help enhance security by isolating one or more applications into a sandbox for execution. Additionally, VMs can be used to more efficiently utilize available computing resources. A VM may be a software version of a computer which can operate like a physical computer to run operating systems and other programs. In some cases, the VM may be allocated physical compute resources, such as from a physical computer and a single physical computer may run multiple VMs. In some examples, one or more VMs may be controlled by a hypervisor. The hypervisor may be software which runs and controls VMs.

In some cases, a hypervisor may be a type 1 hypervisor which does not need to be installed on a host operating system (OS). In some cases, the hypervisor may be integrated with components typically found in an OS, such as those for interacting with hardware components. In some cases, the hypervisor may include a virtualized OS, referred to as a primary VM (PVM), that may be used to access and/or control the hypervisor, or perform other operations. In some examples, the PVM may then host other VMs, such as guest VMs (GVMs), as a hosted hypervisor. A VM executing on a computer, aside from the PVM, may be referred to as a guest VM (GVM) and the physical computer may be referred to as a host machine or device.

In some cases, applications executing on different VMs may need to communicate with each other. As applications running on different VMs are isolated from each other as if they were executing on different devices, information may be passed between VMs using an inter-process communications protocol, such as a socket. As used herein, a socket may be communications channel set up between VMs that enable a first application executing on a first VM to communicate with a second application executing on the second VM based on an identifier associated with the first VM. Examples of sockets may include UNIX sockets, Vsocket, Qsockets, and the like.

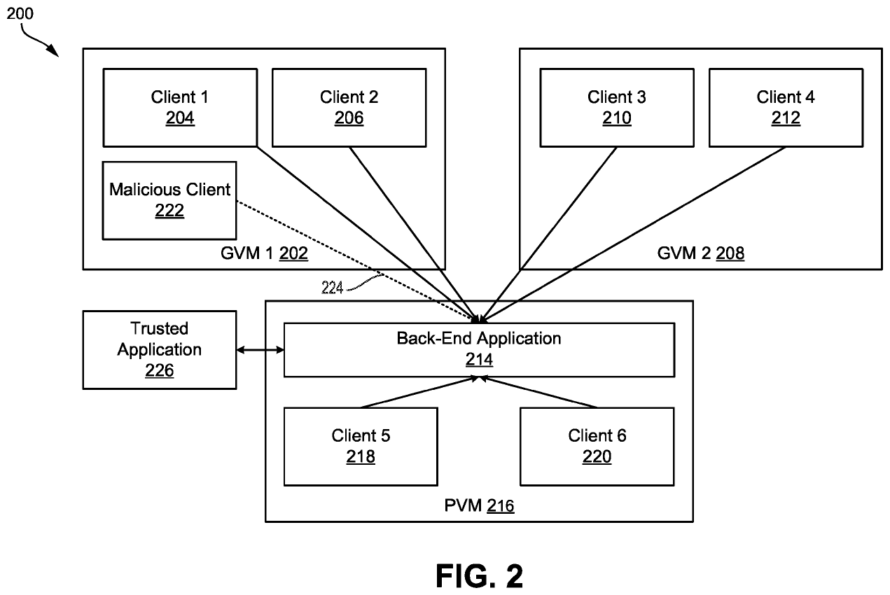

FIG. 2 is a block diagram illustrating communications between a set of VMs 200, in accordance with aspects of the present disclosure. In some cases, there may be a security and/or safety concerns if one VM, such as a GVM disturbs data that is owned by another virtual machine (e.g., PVM or other GVM). As an example, FIG. 2 includes a first GVM 202, which includes a first client application 204 and a second client application 206. FIG. 2 also includes a second GVM 208, which includes a third client application 210, and a fourth client application 212. In some cases, the first GVM 202 and second GVM 208 may be hosted on a same device (e.g., same hardware device) as the PVM 216 or the first GVM 202 and second GVM 208 may be hosted on different devices.

In FIG. 2, the client applications (e.g., the first client application 204, second client application 206, third client application 210, and fourth client application 212) may all communicate with a back-end application 214 (e.g., server application) executing on a PVM 216. The back-end application 214 may communicate with a trusted application 226 to obtain information and pass the obtained information back to the client applications. As a more specific example, the trusted application 226 may be a key generating application for generating security keys and the client applications operating on the first GVM 202 and/or the second GVM 208 can send requests and receive responses using a socket connection with the back-end application 214. In some cases, socket connections may be requested by an application and created by an OS executing on a VM, such as the first GVM 202 or the second GVM 208. The OS may then use a socket identifier of the VM (e.g., socket ID 5021 of the first GVM 202) to establish the socket connection with the back-end application 214. The back-end application 214, executing on the PVM 216 may accept requests with specific socket identifiers (e.g., ID 5021).

The back-end application 214 may process the request for a requesting GVM (e.g., client application executing on the first GVM 202 and/or the second GVM 208), for example, by requesting keys from trusted application 226 and transmitting these keys back to the requesting GVM. In some examples, the back-end application 214 may also receive requests from local client applications, such as fifth client application 218 and sixth client application 220 executing on the PVM 216. In some cases, the trusted application 226 may execute independently of the PVM 216. For example, the trusted application 226 may be executing in a trusted environment, such as a secure hardware module 120 of a device, or on another device (either virtualized or non-virtualized).

In some cases, a malicious client 222 executing on a GVM, such as the first GVM 202, may be able to obtain a socket ID of the GVM the malicious client 222 is executing on (e.g., the first GVM 202), or another GVM, such as the second GVM 208, and can mimic a request from another VM (e.g., a PVM/HOST request) to the back-end application 214 using the socket ID to send 224 a malicious request, such as a delete key request to erase a key related to PVM 216 or another VM (e.g., the second GVM 208), or other valid, but malicious, instruction to the back-end application 214. The back-end application 214 may then forward the instruction to the trusted application 226 for execution. In some cases, what is needed is a mechanism to protect security for a common trusted application, for example, by preventing applications executing on a VM from mimicking (e.g., spoofing) requests from other VMs.

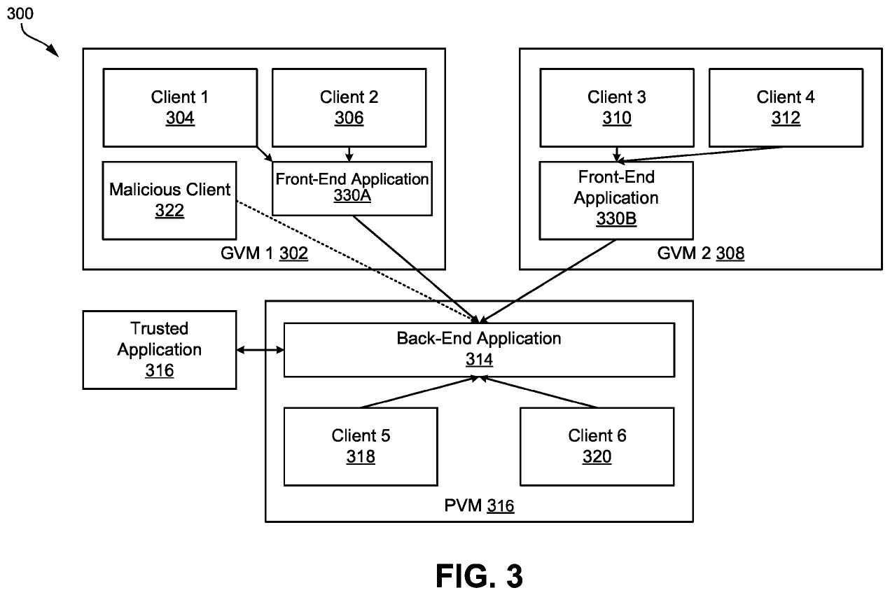

FIG. 3 is a block diagram illustrating protected communications between a set of VMs 300, in accordance with aspects of the present disclosure. FIG. 3, similar to FIG. 2, includes a first GVM 302 having a first client application 304 and a second client application 306, a second GVM 308 having a third client application 310 and a fourth client application 312, and a PVM 316 having a back-end application 314, a fifth client application 318, and a sixth client application 320. In some cases, the first GVM 302, second GVM 308, PVM 316, and trusted application 326 may all be included on a single hardware device, such as a mobile device. In other cases, the first GVM 302, second GVM 308, PVM 316, and/or trusted application 326 may be executing on two or more hardware devices. In some cases, first GVM 302, second GVM 308, PVM 316, and/or trusted application 326 may execute on two or more hardware processors of a single device, such as vehicle.

The first GVM 302 also includes a front-end application 330A, through which the other client applications of the first GVM 302 may access the back-end application 314. In some cases, the front-end applications 330A and 330B (collectively front-end applications 330) may be an application that uses a filter, such as an extended Berkeley packet filter (eBPF) to access another application, such as a back-end application 314. In some cases, a filter, such as the eBPF filter may be a kernel level filter which detects attempts to establish a particular socket connection with the back-end application 314. In some cases, filters may detect messages with a particular UID and/or socket ID and allow the message to be sent if various statistical rules are satisfied. In some cases, the eBPF may provide a network interface and security layer capable of filtering packet data. For example, a front-end application, such as front-end application 330A may be bound with a compile time UID and the operating system kernel may perform filtering based on this application UID and the socket number the GVM, such as the first GVM 302, is being used to communicate with the PVM.

The front-end applications 330 may be assigned (e.g., bound to) a unique user identifier (UID) and may be associated with a particular socket ID (e.g., a Q-Socket ID, such as ID_GVM1). In some cases, the UID is unique to a single application on a VM. In some cases, the UID and socket ID for a VM may be determined at compile time, so no two VMs can have the same UID and socket ID pair. As an example, front-end applications may be compiled per GVM, so the front-end application 330A of GVM 1 302 may have a different UID and socket ID as compared to the front-end application 330B of GVM 2 308. Client applications, such as the first client application 304, second client application 306 for the first GVM 302, the third client application 310 and/or fourth client application 312 of the second GVM 308, may access the back-end application 314 via the front-end applications 330.

In some cases, the client applications may use the UID and socket ID to access the front-end applications 330. For example, the first client application 304 may pass its UID and socket ID to the front-end application 330A to establish a socket connection with the back-end application 314. As a more detailed example, the first client application 304 may use a new key to generate a passcode and the first client application 304 may send a request for the new key to the front-end application with the UID embedded in the request over a socket having the socket ID associated with the front-end application 330A. The front-end application 330A may generate a request for the back-end application with the UID and socket ID and pass the request to a filter in the kernel. The filter may determine if the UID and socket ID are associated with the front-end application 330A. If the UID and socket ID are correct, the front-end application 330A may establish a socket connection to the back-end application 314 and pass the request from the first client application 304 on to the back-end application 314. The back-end application 314 may be able to determine which VM/front-end client application a request is received from based on the port number. For example, the back-end application 314 may match port numbers used to particular VM/front-end client applications. In some cases, the back-end application 314 may indicate, to the trusted application 326, which VM/front-end application is associated with a received request. For example, the back-end application 314 may add an identifier of the particular VM/front-end client to the received request for the trusted application 326. The back-end application 314 may then access the trusted application 326 based on the request and receive a response from the trusted application 326. The back-end application 314 may then send a response to the front-end application 330A based on the response from the trusted application 326. The front-end application 330A may receive the response from the back-end application 314 and the front-end application 330A may forward the response to the appropriate client application (e.g., the first client application 304 in this example).

In some cases, if an application does not have the UID and socket ID associated with a particular VM (e.g., the UID and socket ID do not match the predetermined UID and socket ID), then the application cannot access the back-end application 314. For example, if malicious client 322, executing on the first GVM 302, obtains a UID and socket ID for another VM, such as the second GVM 308, attempts to pass the obtained UID and socket ID in a request to the back-end application 314, the request may be passed to the filter in the kernel and the filter may determine that the UID and/or socket ID do not match the UID and/or socket ID associated with the front-end application 330A. The filter application may then drop the request and the malicious client 322 would not be able to access the back-end application 314 using the UID and socket ID associated with the second GVM 308. In some cases, attempts by the malicious client 322 to directly access the back-end application 314 may be blocked by the filter as the obtained UID and socket ID are incorrect. Thus, the back-end application 314 may be able to trust the requests received from one or more VMs, as a VM cannot send a request with a different UID other than the UID associated to with a particular socket ID at the time of compilation.

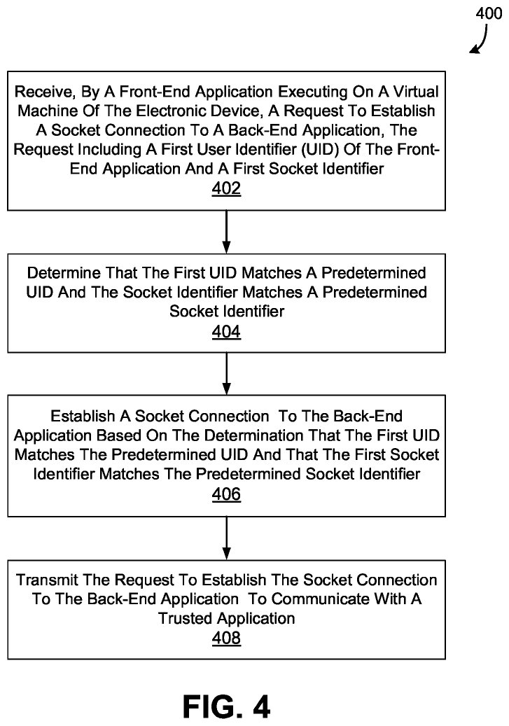

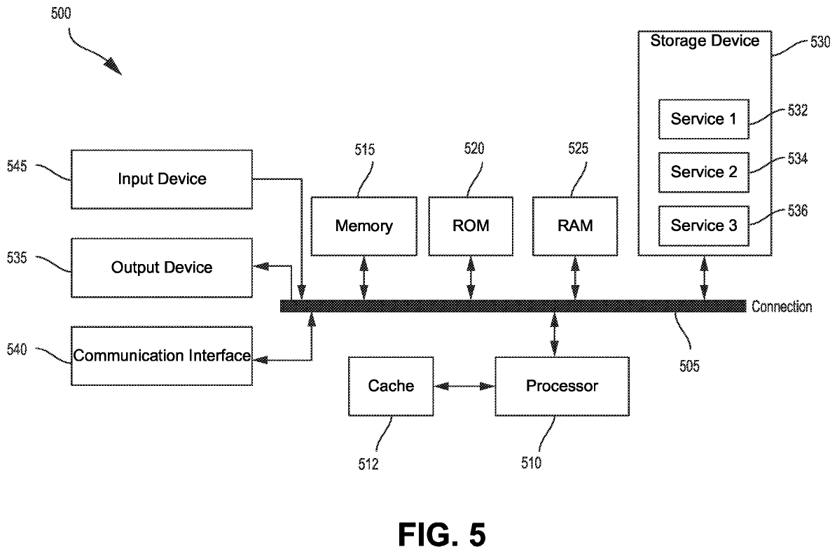

FIG. 4 is a flow diagram illustrating an example of a process 400 for establishing a connection, in accordance with aspects of the present disclosure. The process 400 may be performed by a wireless device or by a component (e.g., SOC 100 of FIG. 1, processor 510 of FIG. 5) or system (e.g., a chipset) of the wireless device (e.g., computing system 500). The electronic device may be a wireless device, such as computing system 500, or a UE (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network node. In some examples, the process 400 may be performed by a UE. The operations of the process 400 may be implemented, in part, as software components that are executed and run on one or more processors (e.g., CPU 102 of FIG. 1, processor 510 of FIG. 5 or other processor(s)).

At block 402, the computing device (or component thereof) may receive, by a front-end application executing on a first virtual machine of an electronic device, a request to establish a first socket connection to a back-end application, the request including a first user identifier (UID) of the front-end application and a first socket identifier. In some cases, the socket to the back-end application (e.g., the socket identifier used by the back-end application and passed (e.g., sent) to the filter) is based on the first socket identifier. In some examples, the request is received from a client application executing on the first virtual machine. In some cases, the back-end application is executing on a second virtual machine on the electronic device.

At block 404, the computing device (or component thereof) may determine that the first UID matches a predetermined UID and that the first socket identifier matches a predetermined socket identifier. In some cases, the predetermined UID and the predetermined socket identifier are predetermined during compilation of the front-end application. For example, the predetermined UID and the predetermined socket identifier may be bound to the application during compilation of the front-end application. The front-end application may be compiled for each virtual machine instance. In some examples, the predetermined UID is unique to the front-end application on the first virtual machine. In some cases, the computing device (or component thereof) may determine that the first UID matches a predetermined UID and that the first socket identifier matches a predetermined socket identifier, by passing the (e.g., sending, transmitting, etc.) first UID and the first socket identifier to a packet filter. A packet filter may be an application (e.g., implemented in software, implemented in hardware, or any combination thereof) which inspects messages (e.g., packets) and can reject (e.g., drop, delete, ignore, etc.) or allow through (e.g., pass through) messages based on certain criteria, such as based on a UID and/or socket identifier associated with the message. In some examples, the packet filter comprises an extended Berkeley packet filter.

At block 406, the computing device (or component thereof) may establish the first socket connection to the back-end application based on the determination that the first UID matches the predetermined UID and the first socket identifier matches the predetermined socket identifier.

At block 408, the computing device (or component thereof) may transmit the request to establish the first socket connection to the back-end application to communicate with a trusted application. In some cases, the computing device (or component thereof) may further receive a response from the back-end application. In some examples, the computing device (or component thereof) may forward the response to the client application. In some cases, the computing device (or component thereof) may further receive an additional request to establish a second socket connection to the back-end application. The computing device (or component thereof) may determine that a second UID or a second socket identifier, of the additional request, do not match the predetermined UID or the predetermined socket identifier. In some examples, this determination is performed by the filter. In some cases, the computing device (or component thereof) may drop the additional request.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 400 and/or other processes described herein may include a processor, microprocessor, micro-computer, or other component of a device that is configured to carry out the steps of the process 400 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 400 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 400 is illustrated as a logical flow diagram, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 400 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 is a diagram illustrating an example of a system for implementing certain aspects of the present technology. In particular, FIG. 5 illustrates an example of computing system 500, which may be for example any computing device making up internal computing system, a remote computing system, a camera, or any component thereof in which the components of the system are in communication with each other using connection 505. Connection 505 may be a physical connection using a bus, or a direct connection into processor 510, such as in a chipset architecture. Connection 505 may also be a virtual connection, networked connection, or logical connection.

In some aspects, computing system 500 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 500 includes at least one processing unit (CPU or processor) 510 and connection 505 that communicatively couples various system components including system memory 525, such as read-only memory (ROM) 520 and random access memory (RAM) 525 to processor 510. Computing system 500 may include a cache 515 of high-speed memory connected directly with, in close proximity to, or integrated as part of processor 510.

Processor 510 may include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which may represent any number of input mechanisms, such as a microphone for speech, a touch-sensitive screen for gesture or graphical input, keyboard, mouse, motion input, speech, etc. Computing system 500 may also include output device 535, which may be one or more of a number of output mechanisms. In some instances, multimodal systems may enable a user to provide multiple types of input/output to communicate with computing system 500.

Computing system 500 may include communications interface 540, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 530 may include software services, servers, services, etc., that when the code that defines such software is executed by the processor 510, it causes the system to perform a function. In some aspects, a hardware service that performs a particular function may include the software component stored in a computer-readable medium in connection with the necessary hardware components, such as processor 510, connection 505, output device 535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An electronic device, comprising: a memory; and a processor coupled to the memory, the processor configured to: receive, by a front-end application executing on a virtual machine of the electronic device, a request to establish a first socket connection to a back-end application, the request including a first user identifier (UID) of the front-end application and a first socket identifier; determine that the first UID matches a predetermined UID and that the first socket identifier matches a predetermined socket identifier; establish the first socket connection to the back-end application based on the determination that the first UID matches the predetermined UID and the first socket identifier matches the predetermined socket identifier; and transmit the request to establish the first socket connection to the back-end application to communicate with a trusted application.

Aspect 2. The electronic device of Aspect 1, wherein the predetermined UID and the predetermined socket identifier are predetermined during compilation of the front-end application.

Aspect 3. The electronic device of any one of Aspects 1 or 2, wherein the socket to the back-end application is based on the first socket identifier.

Aspect 4. The electronic device of any one of Aspects 1 to 3, wherein the predetermined UID is unique to the front-end application on the first virtual machine.

Aspect 5. The electronic device of any one of Aspects 1 to 4, wherein, to determine that the first UID matches a predetermined UID and that the first socket identifier matches a predetermined socket identifier, the processor is configured to send the first UID and the first socket identifier to a packet filter.

Aspect 6. The electronic device of Aspect 5, wherein the packet filter comprises an extended Berkeley packet filter.

Aspect 7. The electronic device of any one of Aspects 1 to 6, wherein the processor is further configured to: receive an additional request to establish a second socket connection to the back-end application; determine that a second UID or a second socket identifier, of the additional request, do not match the predetermined UID or the predetermined socket identifier; and drop the additional request.

Aspect 8. The electronic device of any one of Aspects 1 to 7, wherein the request is received from a client application executing on the first virtual machine.

Aspect 9. The electronic device of Aspect 8, wherein the processor is further configured to: receive a response from the back-end application; and forward the response to the client application.

Aspect 10. The electronic device of any one of Aspects 1 to 9, wherein the back-end application is executing on a second virtual machine on the electronic device.

Aspect 11. The electronic device of any one of Aspects 1 to 10, wherein the electronic device comprises a wireless device.

Aspect 12. A method for establishing a connection comprising: receiving, by a front-end application executing on a first virtual machine of an electronic device, a request to establish a first socket connection to a back-end application, the request including a first user identifier (UID) of the front-end application and a first socket identifier; determining that the first UID matches a predetermined UID and that the first socket identifier matches a predetermined socket identifier; establishing the first socket connection to the back-end application based on the determination that the first UID matches the predetermined UID and the first socket identifier matches the predetermined socket identifier; and transmitting the request to establish the first socket connection to the back-end application to communicate with a trusted application.

Aspect 13. The method of Aspect 12, wherein the predetermined UID and the predetermined socket identifier are predetermined during compilation of the front-end application.

Aspect 14. The method of any one of Aspects 12 or 13, wherein the socket to the back-end application is based on the first socket identifier.

Aspect 15. The method of any one of Aspects 12 to 14, wherein the predetermined UID is unique to the front-end application on the first virtual machine.

Aspect 16. The method of any one of Aspects 12 to 15, wherein determining that the first UID matches a predetermined UID and that the first socket identifier matches a predetermined socket identifier, comprises sending, by the front-end application, the UID and socket identifier to a packet filter.

Aspect 17. The method of Aspect 16, wherein the packet filter comprises an extended Berkeley packet filter.

Aspect 18. The method of any one of Aspects 12 to 17, further comprising: receiving an additional request to establish a second socket connection to the back-end application; determining that a second UID or a second socket identifier, of the additional request, do not match the predetermined UID or the predetermined socket identifier; and dropping the additional request.

Aspect 19. The method of any one of Aspects 12 to 18, wherein the request is received from a client application executing on the first virtual machine.

Aspect 20. The method of Aspect 19, further comprising: receiving a response from the back-end application; and forwarding the response to the client application.

Aspect 21. The method of any one of Aspects 12 to 20, wherein the back-end application is executing on a second virtual machine.

Aspect 22. A non-transitory computer-readable medium having stored thereon instructions that, when executed by a processor, cause the processor to: receive, by a front-end application executing on a first virtual machine of an electronic device, a request to establish a first socket connection to a back-end application, the request including a first user identifier (UID) of the front-end application and a first socket identifier; determine that the first UID matches a predetermined UID and that the first socket identifier matches a predetermined socket identifier; establish a first socket connection to the back-end application based on the determination that the first UID matches the predetermined UID and the first socket identifier matches the predetermined socket identifier; and transmit the request to establish the first socket connection to the back-end application to communicate with a trusted application.

Aspect 23. The non-transitory computer-readable medium of Aspect 22, wherein the predetermined UID and the predetermined socket identifier are predetermined during compilation of the front-end application.

Aspect 24. The non-transitory computer-readable medium of any one of Aspects 22 or 23, wherein the socket to the back-end application is based on the first socket identifier.

Aspect 25. The non-transitory computer-readable medium of any one of Aspects 22 to 24, wherein the predetermined UID is unique to the front-end application on the first virtual machine.

Aspect 26. The non-transitory computer-readable medium of any one of Aspects 22 to 25, wherein, to determine that the first UID matches a predetermined UID and that the first socket identifier matches a predetermined socket identifier, the instructions cause the processor to send the first UID and the first socket identifier to a packet filter.

Aspect 27. The non-transitory computer-readable medium of Aspect 26, wherein the packet filter comprises an extended Berkeley packet filter.

Aspect 28. The non-transitory computer-readable medium of Aspect 27, wherein the instructions further cause the processor to: receive an additional request to establish a second socket connection to the back-end application; determine that a second UID or a second socket identifier, of the additional request, do not match the predetermined UID or the predetermined socket identifier; and drop the additional request.

Aspect 29. The non-transitory computer-readable medium of any one of Aspects 22 to 28, wherein the request is received from a client application executing on the first virtual machine.

Aspect 30. The non-transitory computer-readable medium of Aspect 29, wherein the instructions further cause the processor: receive a response from the back-end application; and forward the response to the client application.

Aspect 31. The non-transitory computer-readable medium of any one of Aspects 22 to 30, wherein the back-end application is executing on a second virtual machine on the electronic device.

Aspect 32. An apparatus for wireless communications, comprising one or more means for performing operations according to any of Aspects 12 to 21.

What is claimed is:

1. An electronic device, comprising:
a memory; and
a processor coupled to the memory, the processor configured to:
receive, by a front-end application executing on a first virtual machine of the electronic device, a request to establish a first socket connection to a back-end application, the request including a first user identifier (UID) of the front-end application and a first socket identifier;
determine that the first UID matches a predetermined UID and that the first socket identifier matches a predetermined socket identifier;
establish the first socket connection to the back-end application based on the determination that the first UID matches the predetermined UID and that the first socket identifier matches the predetermined socket identifier; and
transmit the request to establish the first socket connection to the back-end application to communicate with a trusted application.

2. The electronic device of claim 1, wherein the predetermined UID and the predetermined socket identifier are predetermined during compilation of the front-end application.

3. The electronic device of claim 1, wherein the first socket connection to the back-end application is based on the first socket identifier.

4. The electronic device of claim 1, wherein the predetermined UID is unique to the front-end application on the first virtual machine.

5. The electronic device of claim 1, wherein, to determine that the first UID matches a predetermined UID and that the first socket identifier matches a predetermined socket identifier, the processor is configured to send the first UID and the first socket identifier to a packet filter.

6. The electronic device of claim 5, wherein the packet filter comprises an extended Berkeley packet filter.

7. The electronic device of claim 1, wherein the processor is further configured to:
receive an additional request to establish a second socket connection to the back-end application;
determine that a second UID or a second socket identifier, of the additional request, do not match the predetermined UID or the predetermined socket identifier; and
drop the additional request.

8. The electronic device of claim 1, wherein the request is received from a client application executing on the first virtual machine.

9. The electronic device of claim 8, wherein the processor is further configured to:
receive a response from the back-end application; and
forward the response to the client application.

10. The electronic device of claim 1, wherein the back-end application is executing on a second virtual machine on the electronic device.

11. The electronic device of claim 1, wherein the electronic device comprises a wireless device.

12. A method for establishing a connection comprising:
receiving, by a front-end application executing on a first virtual machine of an electronic device, a request to establish a first socket connection to a back-end application, the request including a first user identifier (UID) of the front-end application and a first socket identifier;
determining that the first UID matches a predetermined UID and that the first socket identifier matches a predetermined socket identifier;
establishing the first socket connection to the back-end application based on the determination that the first UID matches the predetermined UID and the first socket identifier matches the predetermined socket identifier; and
transmitting the request to establish the first socket connection to the back-end application to communicate with a trusted application.

13. The method of claim 12, wherein the predetermined UID and the predetermined socket identifier are predetermined during compilation of the front-end application.

14. The method of claim 12, wherein the first socket connection to the back-end application is based on the first socket identifier.

15. The method of claim 12, wherein the predetermined UID is unique to the front-end application on the first virtual machine.

16. The method of claim 12, wherein determining that the first UID matches a predetermined UID and that the first socket identifier matches a predetermined socket identifier, comprises sending, by the front-end application, the UID and socket identifier to a packet filter.

17. The method of claim 16, wherein the packet filter comprises an extended Berkeley packet filter.

18. The method of claim 12, further comprising:
receiving an additional request to establish a second socket connection to the back-end application;
determining that a second UID or a second socket identifier, of the additional request, do not match the predetermined UID or the predetermined socket identifier; and
dropping the additional request.

19. The method of claim 12, wherein the request is received from a client application executing on the first virtual machine.

20. The method of claim 19, further comprising:
receiving a response from the back-end application; and
forwarding the response to the client application.
